(19) United States
(12) Patent Application Publication
(10) Pub. No.: US 2007/0012739 A1
(43) Pub. Date: Jan. 18, 2007

(54) Motorcycle adaptable sports equipment carrier

(76) Inventor: Mark S. Geuss, Albuquerque, NM (US)

Correspondence Address: Ortiz & Lopez, PLLC, P.O. Box 4484, Albuquerque, NM, 87196, US

(21) Appl. No.: 11/477,135

(22) Filed: Jun. 27, 2006

Related U.S. Application Data
(60) Provisional application No. 60/694,963, filed on Jun. 28, 2005.

(51) Int. Cl. B62J 9/00; B62J 7/00; B62J 11/00

(52) U.S. Cl. 224/413; 224/454; 224/521

(57) ABSTRACT

A sports equipment carrier adapted for use with a motorcycle. The sport equipment carrier includes a support base including a metal frame surrounding an expanded metal floor and a tongue extended outward from the metal frame and adapted for coupling to a motorcycle-based hitch receiver. The tongue fixed to and extends outward from the metal frame and is adapted to be removably coupled to a motorcycle-based hitch receiver. A vertical support frame can be removably secured to the support base and includes at least one sport equipment fastener. The sports equipment retainer can include metal supports, nylon straps and buckles, said straps and buckets securing sporting equipment against the metal supports. The sports equipment carrier can carry golf clubs, skies, luggage, coolers, and other recreational or work equipment.

### INVENTION PRIORITY

The present invention claims priority to Provisional Patent application no. 60/694,963, filed Jun. 28, 2005 by Mark S. Geuss, a U.S. Citizen residing in Albuquerque, N.Mex.

### TECHNICAL FIELD

The invention is related to carrier device. The invention is also related to motorcycle/motorscooter/motor-bike, two-wheeler (hereinafter collectively referred to as a motorcycle) accessories. More particularly, the present invention is related to a sporting equipment carrier adapted for use with motorcycles. Sporting equipment that can be carried by the carrier include golf bags, skis, snowboards, and the like.

### BACKGROUND

Motorcycle use is growing as gas prices and traffic congestion increase. Unfortunately, not much in terms of large luggage or sporting equipment such as golf clubs can be transported on a motorcycle without affecting the overall balance or profile of the motorcycle. What is needed is a sports equipment carrier that can accommodate large, or even long, equipment without affecting the weight-balance factor or overall profile of the motorcycle. The present inventor believes the current invention can accomplish all the objectives not currently provided by the prior art with his unique design.

### SUMMARY OF THE INVENTION

The sporting equipment carrier in accordance with embodiments of the present invention includes a support base and hitch tongue. The support base includes expanded metal flooring (mesh-like metal) to enable for ease of cleaning and water drainage, and a sturdy metal frame.

In accordance with another feature of the invention, a vertical bar receiver can be included as part of the frame supporting the expanded metal floor is. The vertical bar receiver is adapted to receive and secure a vertical bar with at least one bolt. The vertical bar is further adapted with strapping and metal supports used to secure sporting equipment (e.g., golf bags, skis, snowboards, etc.).

In accordance with another feature of the invention, the vertical bar can include, for example, upper and lower equipment fasteners, which can be provided in the form of metal brackets that include nylon straps with buckles, to secure a golf bag to the vertical bar and support base.

In accordance with yet another feature of the invention, the tongue is adaptable to secure the carrier to at least one of a vertical hitch receiver, horizontal hitch receiver, and/or ball receiver.

### BRIEF DESCRIPTION OF THE DRAWINGS

FIG. 1 illustrates a perspective view of a sports equipment carrier in accordance with some of the features of the invention.

FIG. 2 illustrates a side view of the carrier in FIG. 1 mounted to a motorcycle equipped with a cargo hold.

FIG. 3 illustrates a front view of the carrier in FIG. 2 mounted to the backside of a motorcycle equipped with a cargo hold.

FIG. 4 illustrates a top view of the base in FIG. 1.

FIG. 5 illustrates a side view of the hitch coupling.

### DETAILED DESCRIPTION

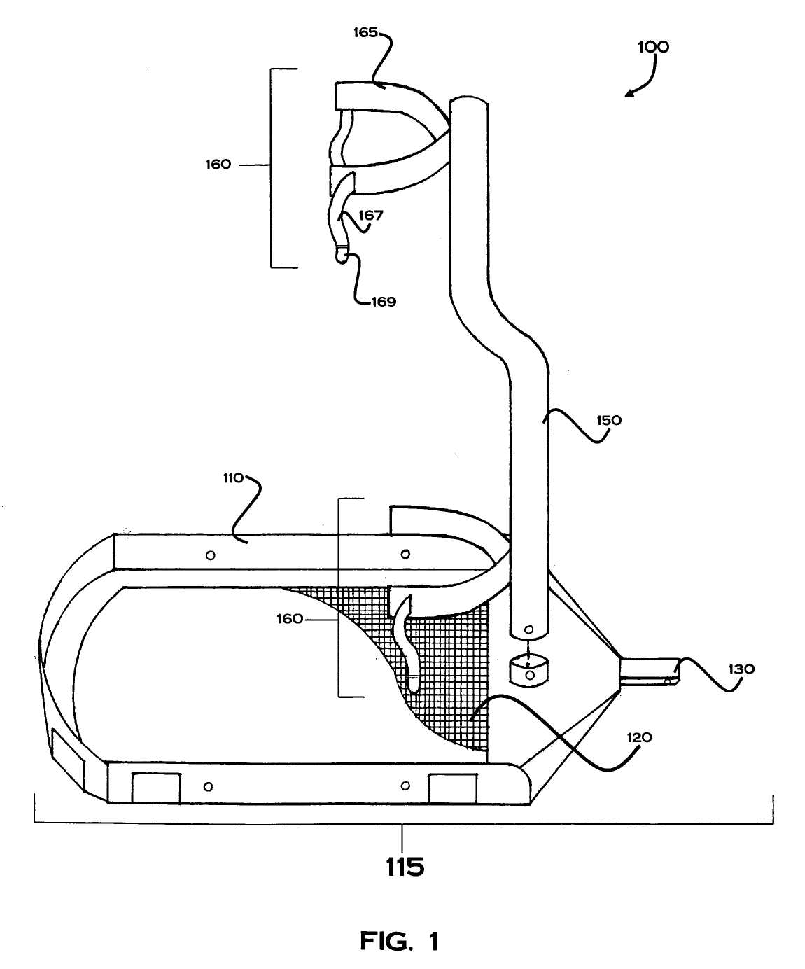

Referring FIG. 1, a side, perspective view of a sports equipment carrier 100 adapted for use with a motorcycle and associated hitch is illustrated. The sport equipment carrier 100 includes a support base 110 including a metal frame 115 surrounding an expanded metal floor 120 and a tongue 130 extended outward from the metal frame 115 and adapted for coupling to a motorcycle-based hitch receiver (not shown). For basic use to carry, for example, luggage coolers, a toolbox or other low profile cargo, only the support base 110 with attachment to a motorcycle hitch would need to be used. But If longer equipment, such as skies or golf clubs, require carrying via motorcycle, then a vertical support frame 150 that is removably securable to the support base 110 can be also used and forms an optional portion of the sports equipment carrier 100.

The vertical support frame 150 ideally includes at least one sport equipment retainers 160. The sports equipment retainer 160 can include a combination of at least one metal support member 165, nylon straps 167 and buckles 169. The nylon straps 167 and buckles 169 secure long sporting equipment, such as a golf bag, against the metal support members 165. The metal support(s) 165 are ideally formed in an arc-like shape so that the sports equipment can be cradle or partially surrounded and thereby secured into the carrier 100. The nylon straps 167 and/or buckles 169 aid to hold sports equipment within and against the metal support member(s) 165.

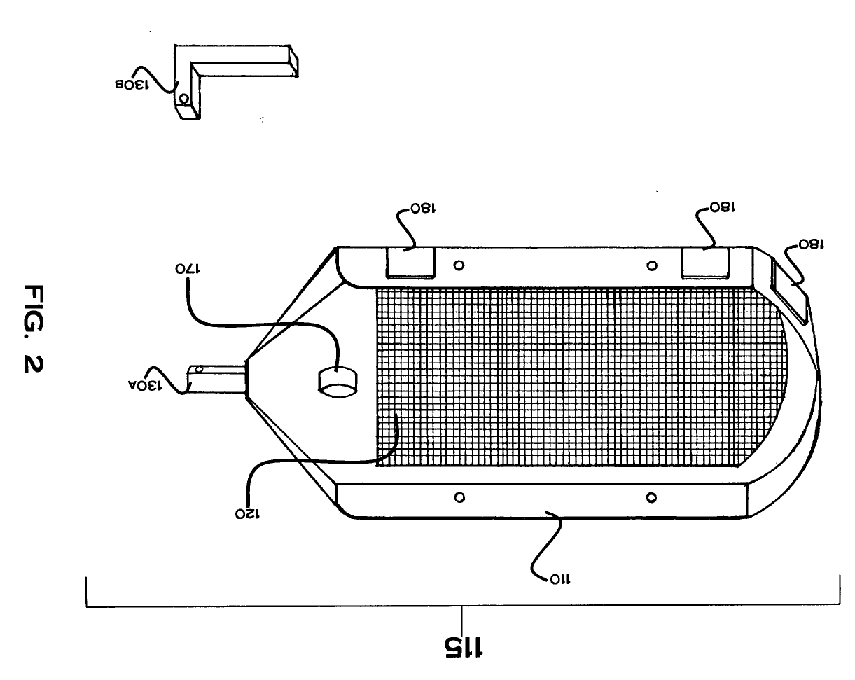

Referring to FIG. 2, a side perspective view of the support base 110 is shown. A support frame receiver 170, similar to a hitch receiver, is formed at the front edge of the support base 100 near the tongue 130. The vertical support frame 150 is removably coupled to the base 110 within the support frame receiver 170, and fastening hardware 175 such as bolts, pins, or screws.

Because the sport equipment carrier 100 extends from the back of a motorcycle, safety can be addressed through the use optional safety illuminators 180, such as reflectors or lights, as shown in FIGS. 1 and 2. Reflectors can be adhered to the frame 115, using fastening means known in the art (e.g., glue, bolts, screws). Where lights are used, electrical connections known in the art would need to be accomplished with installation of the base 110 to the motorcycle hitch receiver (not shown). Lights can be installed to the frame 115 in the same manner as reflectors.

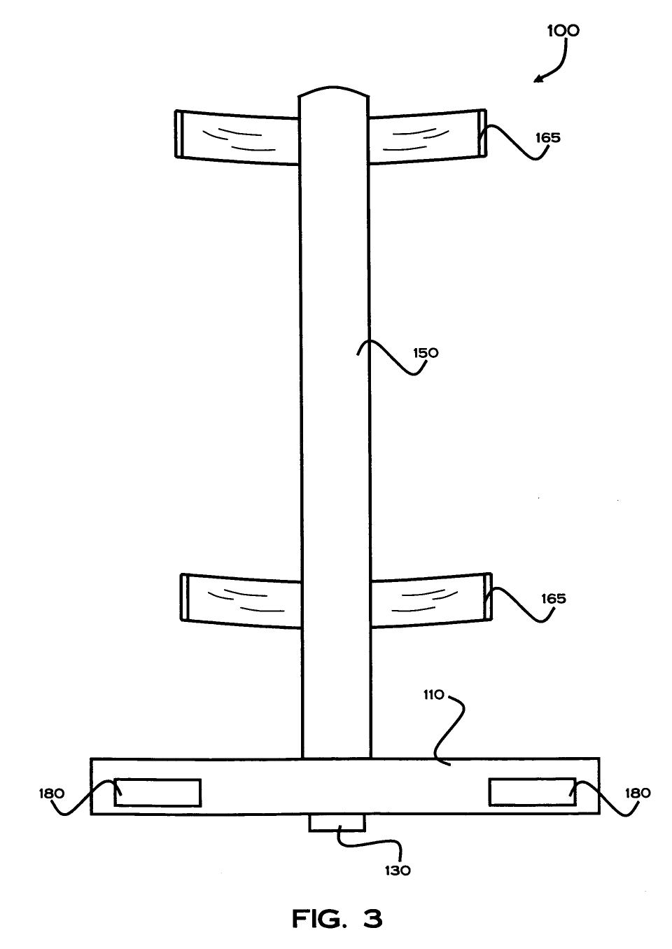

Referring to FIG. 3, a rear perspective view of the sport equipment carrier 100 including a support base 110 and vertical support frame 150. The sport equipment carrier 100 is also shown with two support members 165. Two illuminators 180 are also shown visible from the rear of the sports equipment carrier 100.

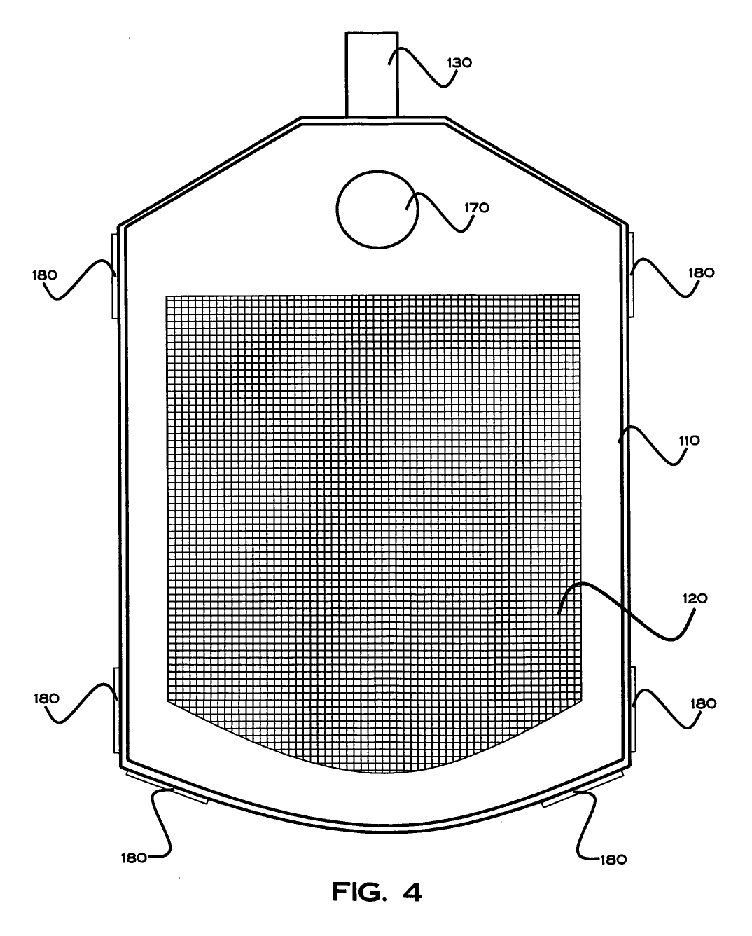

Referring to FIG. 4, a top view of a support base 110 is shown. The support base110 includes expanded metal flooring 120, which can be provided in the form of rugged metal mesh known in the art. Also shown from the top perspective of the support base 110 is the vertical support frame receiver 170 and the tongue 130. Optional illuminators 180 are shown at various locations outside of the metal frame 115.

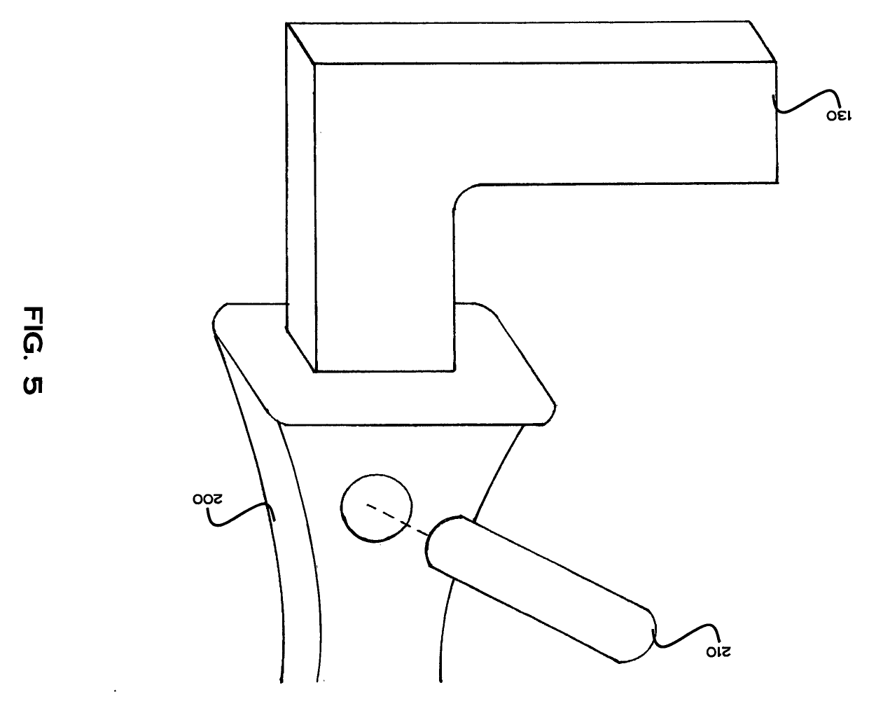

Referring to FIG. 5, a close up perspective view of the tongue's 130 coupling with a hitch receiver 200 associated with a motorcycle (not shown) is illustrated. As shown in FIG. 5, the tongue 130 is received by the hitch receiver 200 and a removable pin 210 holds the tongue in place within the hitch 200. The tongue as shown is formed at a 90-degree angle with the floor's surface. Some motorcycle hitches are configured to receive tongues vertically. It should be appreciated, however, that the tongue can be oriented horizontally for receipt by horizontally configured hitch receivers.

1. A sports equipment carrier comprising a support base including a metal frame surrounding an expanded metal floor and a tongue extended outward from the metal frame and adapted for coupling to a motorcycle-based hitch receiver.

2. A sports equipment carrier comprising:
a support base further including a metal frame surrounding an expanded metal floor, a tongue secured to and extended outward from the metal frame and adapted for use with a motorcycle-based hitch receiver; and
a vertical support frame removably securable to the support base and including at least one sport equipment retainer.

3. The sports equipment carrier of claim 2, wherein said sports equipment fastener includes metal supports, nylon straps and buckles, said straps and buckles securing sporting equipment against the metal supports.

4. The sports equipment carrier of claim 1 further comprising a vertical support frame removably securable to the support base and including at least one sport equipment fastener.

5. The sports equipment carrier of claim 2 further comprising a vertical support frame removably securable to the support base and including at least one sports equipment retainer.

6. The sports equipment carrier of claim 5 wherein said sports equipment retainer further comprises at least one metal support member.

7. The sports equipment carrier of claim 5 wherein said sports equipment retainer further comprises a combination of at least one metal support member and nylon straps including buckles, wherein the nylon straps and buckles aid to secure long sporting equipment within and against the metal support members.

8. The sports equipment carrier of claim 6 wherein said at least one metal support member is formed in an arc-like shape so that the sports equipment can cradle or partially surrounded and thereby secure sports equipment the sport equipment carrier.

9. The sports equipment carrier of claim 8 further comprising nylon straps adapted to hold sports equipment within and against the at least one metal support member.

10. The sports equipment carrier of claim 9 further comprising buckles operable with said nylon straps to hold sports equipment within and against the at least one metal support member.

11. The sports equipment carrier of claim 2 wherein said sports equipment retainer further comprises at least one metal support member.

12. The sports equipment carrier of claim 11 wherein said sports equipment retainer further comprises a combination of at least one metal support member and nylon straps including buckles, wherein the nylon straps and buckles aid to secure long sporting equipment within and against the metal support members.

13. The sports equipment carrier of claim 12 wherein said at least one metal support member is formed in an arc-like shape so that the sports equipment can cradle or partially surrounded and thereby secure sports equipment the sport equipment carrier.

14. The sports equipment carrier of claim 13 further comprising nylon straps adapted to hold sports equipment within and against the at least one metal support member.

15. The sports equipment carrier of claim 14 further comprising buckles operable with said nylon straps to hold sports equipment within and against the at least one metal support member.

16. A sports equipment carrier comprising:
a support base further including a metal frame surrounding an expanded metal floor,
a tongue secured to and extended outward from the metal frame and adapted for use with a motorcycle-based hitch receiver;
a vertical support frame removably securable to the support base and including at least one sport equipment retainer provided in the form of a metal support member; and
nylon straps adapted to hold sports equipment within and against the at least one metal support member.

17. The sports equipment carrier of claim 16 wherein said at least one metal support member is formed in an arc-like shape so that the sports equipment can cradle or partially surrounded and thereby secure sports equipment the sport equipment carrier.

18. The sports equipment carrier of claim 17 further comprising buckles operable with said nylon straps to hold sports equipment within and against the at least one metal support member.
